(19) United States
(12) Patent Application Publication
(10) Pub. No.: US 2026/0186468 A1
(43) Pub. Date: Jul. 2, 2026

(54) CONTEXTUALIZATION ENGINE FOR INDUSTRIAL DATA

(71) Applicant: OPTIMISTIK, CHAMBERY (FR)

(72) Inventors: Mathieu CURA, CHAMBERY (FR); Marouane HASSANI, CHAMBERY (FR); Arthur MARTEL, CHAMBERY (FR)

(73) Assignee: OPTIMISTIK, CHAMBERY (FR)

(21) Appl. No.: 18/855,220

(22) PCT Filed: Mar. 22, 2023
(86) PCT No.: PCT/IB2023/052796

§ 371 Date: Oct. 8, 2024

(30) Foreign Application Priority Data
Apr. 16, 2022 (FR) FR2203577

(51) Int. Cl. G05B 19/418

(52) U.S. Cl. CPC G05B 19/4183

(57) ABSTRACT

A method for processing sensor data of an industrial installation for controlling at least one piece of equipment of said installation, the method comprising the following steps: extraction of sensor data relating to a phase of an operation carried out within said industrial plant, generation of traceability data relating to a position of said phase in a flow of operations within said industrial plant, aggregation of said sensor data and said traceability data to generate operation data specific to said operation in said flow.

### TECHNICAL FIELD

The present invention relates to a method for processing sensor data from an industrial plant to ensure optimization by controlling its equipment.

The invention makes it possible to create contextualization engines for industrial production process data, for monitoring, controlling and optimizing these processes and associated equipment.

### TECHNOLOGICAL BACKGROUND

The management of industrial production processes requires the processing of a large amount of data from various sensors. These sensors provide information on a large number of parameters, providing information on the state of a wide range of equipment operating in different phases and/or regimes. The same equipment may operate with different parameters according to a given operating phase within a given operation of the overall production process.

Knowledge of the exact course of the process is key to monitoring, controlling and optimizing the industrial plant.

In the process industry, particularly in batch processes, this is the main obstacle to exploiting sensor data beyond simple monitoring.

In this type of process, the finished product is obtained after a series of tasks, rather than continuously. Batch process control in industry is used in many fields: food, chemicals, pharmaceuticals, cosmetics, biotechnology, brewing, plant protection, detergents, enzymes, paints, metallurgy, materials, and many others. In all these fields, there is a need for fine, constant control of the mixtures and dosages of the various reagents involved in the production process of the final product, as well as the conditions under which this production process is carried out.

For manufacturers, mastery of batch process control is a guarantee of quality and productivity. However, these processes must comply with strict traceability rules, as well as quality and control controls.

Industries using batch process control generally need to manufacture different products from identical equipment structures: for example, a quantity of white paint followed by the same quantity of black paint for the same tank, which may or may not involve allowing time for changeover and/or cleaning. Equipment is therefore used for a variety of operations, which may themselves involve different phases.

Batch processes therefore enable us to achieve a high degree of flexibility in production, and even reduce design times for new products. However, this requires rigorous process monitoring and full traceability of the batches produced.

Various approaches have been proposed to meet this need for monitoring.

Most are based on tracking time series of sensor data with a data model to describe production operations. These solutions visualize sensor time curves, with a start and end corresponding to those of the corresponding operation.

However, these solutions have a number of drawbacks. They do not provide a global approach to processes. Data is made available sensor by sensor, and only as a function of time. This makes it difficult and time-consuming to gain an overall understanding of the process and the problems that may arise when an anomaly is detected. This makes it extremely complex, if not impossible under certain conditions, to monitor, control and optimize processes.

There is therefore a need to improve the processing of sensor data from industrial plants to ensure optimization through equipment control. In particular, there is a need for an industrial tool to simplify and facilitate the monitoring, control and optimization of processes and equipment associated with such facilities.

The present invention falls within this framework.

### SUMMARY OF THE INVENTION

According to a first aspect, the invention relates to a method for processing sensor data of an industrial installation for controlling at least one piece of equipment of said installation, the method comprising the following steps:
extraction of state data relating to a phase of an operation carried out within said industrial plant,
generation of traceability data relating to a position of said phase in a flow of operations within said industrial plant,
aggregation of said state data and said traceability data to generate operation data specific to said operation in said flow.

A method according to the first aspect enables sensor data from a production process to be contextualized in a standardized way as a function of production monitoring (traceability and genealogy) to simplify and facilitate the monitoring, control and optimization of this process and associated equipment.

Such a method reduces the time, effort and cost required to improve the performance of industrial installations as they exist, for example, in factories. It also speeds up the analysis of real-time and off-line data to identify the root cause of process inefficiencies.

The embodiments of the invention offer an industrial process engineering tool. The embodiments enable the behavior of industrial processes to be monitored, controlled and optimized in a practical way. It is thus possible to guide their improvement with sufficient precision, and in reasonable time and cost.

The embodiments of the invention thus offer the industrial tool that is lacking today in the development of industrial plants. Purely intellectual processing of sensor data is not possible. In practice, it is impossible to carry out the calculations required to arrive at sufficiently precise and significant results to enable the necessary industrial decisions to be made in an industrially reasonable time.

For example, the generation of operation data involves the application of a time window relative to said phase of said operation.

For example, the generation of operation data includes the location of data relating to said phase of said operation.

According to embodiments, the operation data is transmitted to a control module of said at least one piece of equipment.

The method according to the first aspect may further comprise the following steps:
generation of genealogy data relating to a sequencing of said operation in said flow of operations within said industrial plant,
aggregation of said operation and genealogy data.

For example, the generation of genealogy data involves the creation of a link relating to their data between one or more downstream operations using products from one or more upstream operations in a process implemented within said plant.

For example, genealogy data can be used to determine data for one or more downstream operations from data relating to one or more upstream operations by applying a function representative of said link.

According to embodiments, the operation performed within said industrial plant is an upstream operation whose results are used by a plurality of downstream operations, and wherein said operation data specific to said upstream operation generated is used for the generation of operation data specific to said downstream operations.

According to embodiments, the operation performed within said industrial plant is a downstream operation using results from a plurality of upstream operations, and wherein the generation of said operation data specific to said downstream operation comprises the application of a function for merging operation data specific to said upstream operations.

According to embodiments, the aggregation of said operation and genealogy data is stored in a data structure comprising
a first set of data describing the operations of said operation flow,
a second set of data describing the equipment of said installation for implementing said operations of said flow of operations and associated with said sensors of said installation,
a third set of data comprising said aggregation of said data.

For example, the first data set comprises, for each operation of said flow, a subset of data describing the operating phases of said operation.

For example, the third data set includes, for each operation of said flow, a genealogy type for indicating a sequencing link between said operations of said flow of operations.

According to embodiments, the aggregation of said operation and genealogy data is transmitted to a control module of said at least one piece of equipment.

According to embodiments, the state data comprises at least one of data from sensors of said plant and values of state variables of equipment of said plant.

According to a second aspect, the invention relates to a device for implementing a method according to the first aspect.

### BRIEF DESCRIPTION OF FIGURES

Further features and advantages of the invention will become apparent from the following detailed description, by way of a non-limiting example, and from the appended figures, which include the following:

FIG. 1 illustrates a context of implementation of embodiments,

FIG. 2 illustrates a data structure for describing a production process,

FIG. 3 illustrates a data structure for the description of an operation in the production process,

FIG. 4 illustrates a genealogy data structure, according to embodiments,

FIG. 5 illustrates a data fusion module according to embodiments,

FIG. 6 illustrates a first type of genealogy, according to embodiments,

FIG. 7 illustrates a second type of genealogy, according to embodiments,

FIG. 8 is a process step diagram according to embodiments,

FIG. 9 schematically illustrates a device according to embodiments,

FIG. 10 schematically illustrates the implementation of a method according to embodiments in a food production facility.

### DETAILED DESCRIPTION OF THE INVENTION

As will become apparent from the detailed description, the embodiments of the invention enable data from sensors associated with equipment in an industrial plant to be contextualized.

This contextualization can, for example, be based on the state at a given moment of the installation in which these sensors are present.

Contextualization can be achieved by enabling data “traceability”. For example, according to the operating cycle of the equipment, the operation, the production phase or other.

This contextualization can also be achieved by associating data with a “genealogy”. This means propagating information from sensors throughout the production process and its constituent stages.

This makes it possible to give context to the information provided by the sensors, based on the way in which the process is being or has been run. In this way, the right information can be built up, enabling production to be monitored, controlled and optimized.

The data processed in this way can be used to combine the spatial context (in which equipment) and temporal aspects (when a particular operation or phase took place) of the installation.

In this way, the processes according to the various embodiments enable sensor data to be aggregated by combining the sensor data with the context of the industrial process, which is necessary for monitoring, controlling and optimizing the processes in question.

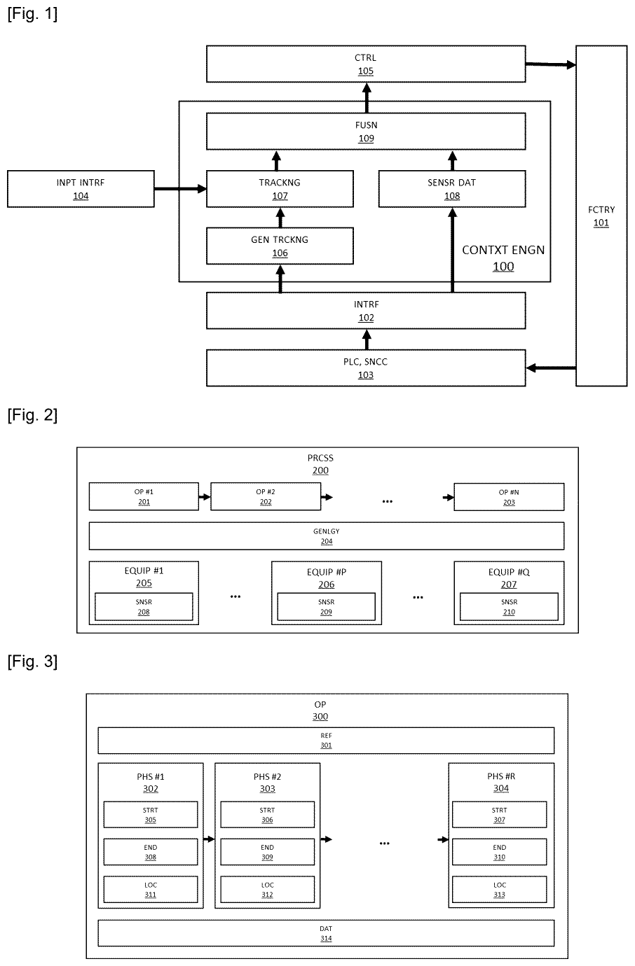

FIG. 1 illustrates an example of a contextualization engine. A contextualization engine 100 processes data from various sensors on the equipment of an industrial plant 101 implementing a production process. The engine 100 receives data via a real-time interface 102, which connects it to an automated process control system 103. It also receives data entered directly by operators via a man-machine interface 104.

The data received from interface 104 relates, for example, to data useful for process control. The automated process control system 103 is, for example, of the SNCC type (acronym for “Système Numérique de Contrôle Commande”, sometimes also called DCS, acronym for “Distributed Control System”). This type of system enables the control of industrial processes, with an interface enabling supervision by operators and digital communication with the industrial installation and its control infrastructures. System 103 can also be, again for example, a PLC (acronym for Programmable Logic Controller). This type of system is a programmable logic controller designed to control industrial processes using sequential processing. It generates and sends computerized commands to actuators in the industrial plant, based on sensor data.

The contextualization engine 100 also communicates with a control system 105 of the industrial plant 101. This system uses the contextualization engine's processing to monitor, control, analyze and/or optimize the process implemented by the industrial plant.

The contextualization engine is processed by various modules. Module 106 is a traceability and genealogy generator. As described in the following, it enables the tracking of state data of the industrial plant from the point of view of the progress of the various stages of the process implemented by the plant. The state data may comprise sensor data and/or state variable values from plant equipment. These state variable values may, for example, come from the 103 automated control system. A state variable may give an indication of the operating phase in which a piece of plant equipment is located. Module 106 generates traceability and genealogy information to feed module 107 from data received via interface 102.

The contextualization engine also includes a module 107 for monitoring production within the plant on the basis of data received from interface 104 and module 106. The data from this module 107 is then processed by a data fusion module 109, which aggregates it with the sensor data received and processed by a module 108 connected to the interface 102.

The contextualization engine is based on a data structure illustrated in FIG. 2.

The purpose of this data structure is to reproduce and digitally represent the production process implemented by plant 101. It provides a standardized, exhaustive description of the process and the data attached to it.

The process implemented by industrial plant 101 is described by means of a set of data 200 respectively describing operations (OP #1 . . . . N) 201, 202, . . . , 203 of an operation flow. These operations are implemented by means of various pieces of equipment (EQUIP #1 . . . . P . . . . Q) described by a data set 205, . . . , 206, . . . , 207. Each of these pieces of equipment is associated with respective sensors (SNSR), 208, . . . , 209, . . . , 210, enabling state information to be obtained from these pieces of equipment (e.g. temperature, pressure or other physical parameters).

Each operation is described according to the data structure 300 shown in FIG. 3. An operation (OP) has a unique operation reference (REF) 301, which enables it to be uniquely identified. It is also described by a set of traceability data 302, 303, . . . , 304 describing successive phases (PHS #1 . . . . R) of the operation. Each phase is described by means of data comprising data representative of a respective starting point (STRT) 305, 306, 307 and data representative of an end (END) 308, 309, 310. Each phase is also associated with data 311, 312, 313 indicating the location (LOC) of the equipment implementing it. Finally, the operation described can also be described by means of other data stored in a structure 314 (DAT) provided for this purpose.

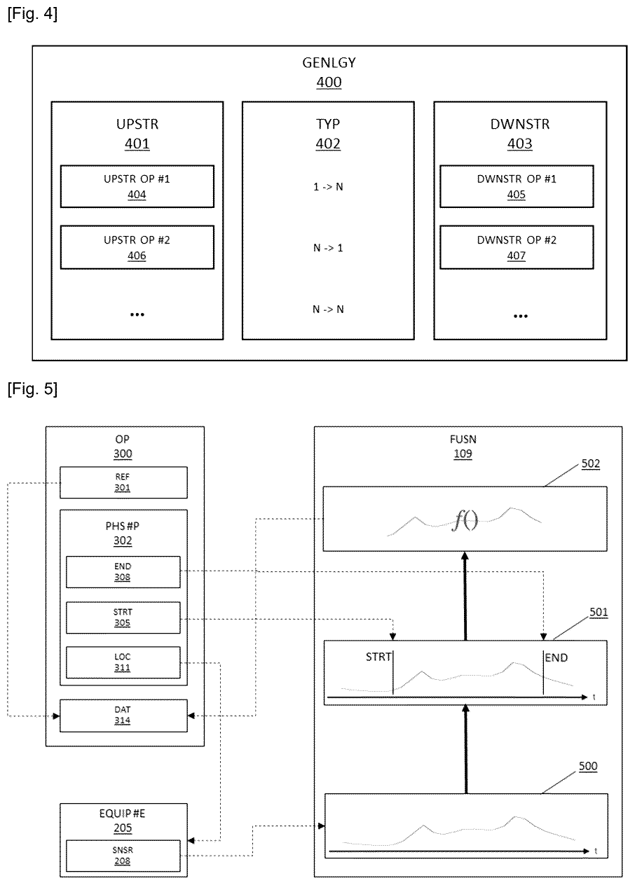

The process is also described by means of so-called “genealogy” data (GNLGY) 204, which links the sensor data from the various pieces of equipment in terms of the flow of operations during which they were acquired. This flow of operations is that described by data 201, 202, . . . , 203. Genealogy data 204 is described in more detail with reference to FIG. 4.

This figure illustrates data (GNLGY) 400 which links a data set (UPSTR) 401 representing upstream operations and a data set (DWNSTR) 403 representing downstream operations. Each data set comprises respective upstream data (404, 404) and downstream data (405, 406) describing operations in the process implemented by the industrial plant. Genealogy type (TYP) data 402 indicates the type of link between operations, for example whether a downstream operation is linked to several upstream operations (or vice versa-type 1→N or N→1), or whether several upstream operations are linked to several downstream operations (type N→N).

Some of the data described above, in particular traceability and genealogy data, are generated by the traceability and genealogy generator. This module takes as input data from automated driving systems. In particular, the generator takes input data representing equipment state. For example, for a given piece of equipment (or set of equipment), it can take as input the phase it is in at a given moment.

The data structure described above enables the data fusion module to combine data at two levels. Firstly, the module merges traceability data with sensor data to construct data characteristic of an operation. Secondly, the module merges traceability data with data associated with operations.

At the first level, as shown in FIG. 5, the data fusion module (FSN) 109 combines traceability data (e.g. start of phase, end of phase, location of phase in equipment) with sensor data to generate an operation-related data item. This figure repeats the data structure of FIG. 2.

Firstly, in step 500, the data fusion module 109 selects the sensors 208 attached to the equipment 205 corresponding to the location of the phase 302 concerned. Secondly, for these sensors, it selects, in step 501, the time window framed by the start and end of the phase concerned, as given by modules 305 and 308. Thirdly, in step 502, it aggregates the sensor data in this window with a transformation function (f).

The calculations performed by the data fusion module can be performed on-the-fly (each time the data attached to the operation is requested) to ensure that the data is always up to date. It can also be a stored pre-calculation with rules for triggering calculation updates, to enable massive query launches on a large number of operations for uses that require it.

At the second level, data from one or more upstream operations is propagated to one or more downstream operations. Propagation processes depend on the type of genealogy involved.

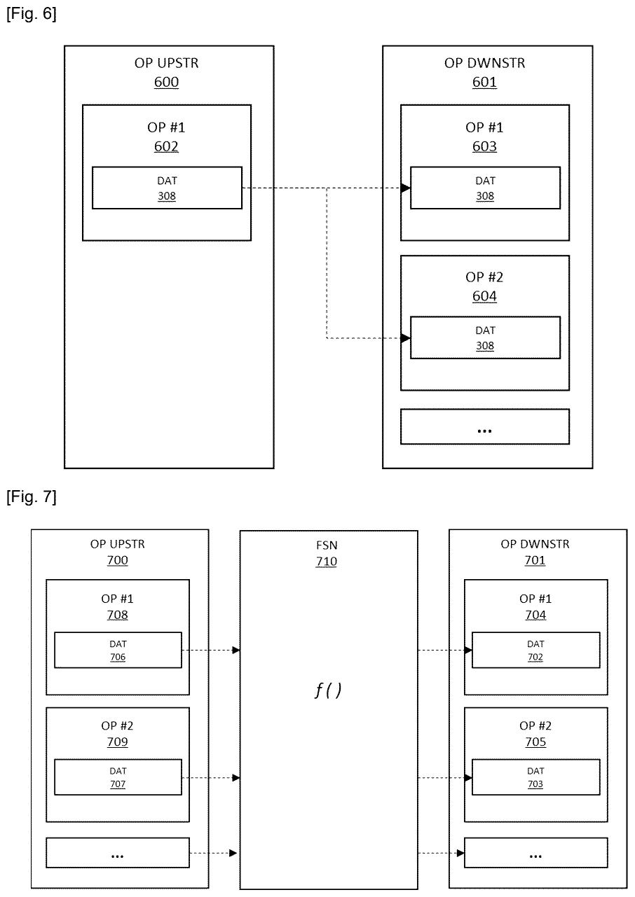

FIG. 6 illustrates a 1→N genealogy. The results of upstream operations represented by upstream operation data 600 are used by downstream operations represented by downstream operation data 601. In the illustrated case, an upstream operation 602 is followed by two downstream operations 603 and 604. The data 605 of operation 602 is propagated as-is and reused as the own data 606 and 607 of operations 603 and 604 respectively. For example, a product A with characteristic X and value Y is produced in operation 602. Downstream operations 603 and 604 using the product from this upstream operation retrieve the value Y for this characteristic X.

FIG. 7 illustrates an N→N or N→1 genealogy. The results of upstream operations represented by upstream operation data 700 are used by downstream operations represented by downstream operation data 701. In this case, processing is performed to generate the data 702, 703 associated with the downstream operations 704, 705, as several upstream operation data 706, 707 708, 709 are required to construct each of them. So, for example, a product A with a characteristic X having a value Y is produced in upstream operations 708, 709. A downstream operation 704 or 705 uses the product from these different upstream operations. To obtain the Y value of characteristic X for this downstream operation, a function f is applied by a data fusion module 710 to the Y values of characteristic X of the upstream batches. For example, this is a weighted sum. The values can be weighted by the masses of product used in the various upstream operations. Of course, other functions or processing can be envisaged depending on the process implemented.

In view of the foregoing, it would appear that the methods of implementation make it possible to provide industrialists faced with the problem of managing the data collected within their industrial facilities to enable them to optimize the processes they implement. These embodiments offer a standardized data structure for describing production operations and phases, and thus standardize the way in which genealogy and traceability (i.e. production tracking) data is structured. The generation of traceability and genealogy data enables the data structure to be fed in the expected form, and thus to adapt to the form in which these data are available in automated control systems. Data fusion as described enables operation-related data to be generated by combining production monitoring data with sensor data. In particular, this data fusion makes it possible to combine sensor data with traceability data to systematically obtain aggregated information at the scale of an operation phase. It also enables data from one or more upstream operations to be combined with one or more downstream operations, thanks to genealogy.

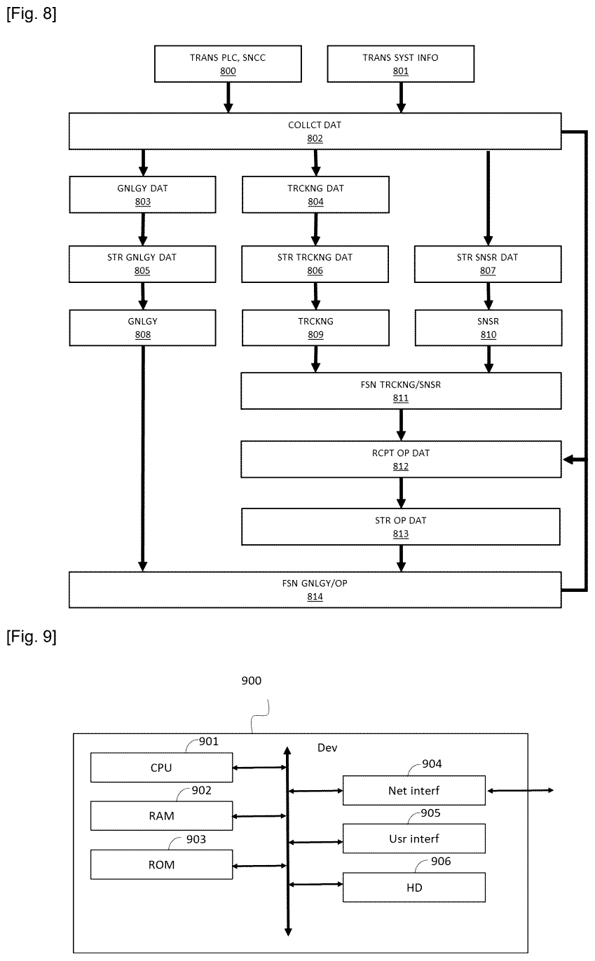

The steps of a method according to embodiments is summarized with reference to FIG. 8, which is a flowchart of steps.

In a step 800, data from an automated process control system controlling an industrial plant is transmitted. In parallel, in a step 801, other complementary data relating to the installation may also be transmitted by other information systems. For example, data transmitted by operators via a man-machine interface, as already described.

The contextualization engine implementing the method receives this data in a collection step 802, which is then routed to the various engine modules for processing.

In step 803, data relating to the genealogy of the sensor data is extracted and stored in step 805. This data is then used to create, in a step 808, the genealogy data in accordance with the structure described above to link upstream and downstream operation data.

In parallel, in step 804, data relating to the traceability of sensor data is extracted and stored in step 806. This data is then used to generate, in a step 809, the traceability data in accordance with the structure described above, enabling the successive phases of the operations from which the data originates to be described (start and end points, location of phases in terms of equipment used, etc.).

The sensor data itself is also extracted in step 807 and stored in step 810.

As described above, the traceability data is aggregated with the sensor data in step 811. The aggregation of these data is then used to generate operation data specific to the operations implemented, in step 813. This generation is based on the operation data extracted from the previously collected data in step 812.

Finally, the genealogy data and the operation data are aggregated in step 814 for transmission to the plant control module. In this way, the control module has all the information it needs to optimally control the plant. In addition to the raw sensor data, the control module has a means of knowing exactly the context in which they were collected.

A method according to embodiments can be implemented in different ways. It can be implemented by a computer connected to the industrial plant. For example, a method according to embodiment can be implemented as part of so-called “on prem” solutions. It can also be implemented on a remote computer remotely connected to the installation. In this way, a process according to the embodiment can be implemented within the framework of so-called “SaaS” solutions (acronym for “Software as a Service”).

FIG. 9 is a block diagram of a 900 system for implementing one or more embodiments of the invention. The systems or servers described above may have the same structure.

System 900 comprises a communication bus to which are connected:
a processing unit 901, such as a microprocessor, called CPU;
a 902 RAM unit for storing the executable code of a process according to one embodiment of the invention, as well as registers suitable for storing the variables and parameters required to implement a process according to other embodiments, the memory capacity of which can be extended by an optional RAM connected to an expansion port, for example;
a memory unit 903, called ROM, for storing computer programs designed to implement the invention;
a network interface unit 904 connected to a communication network over which the digital data to be processed is transmitted or received. The network interface 904 may be a single network interface, or composed of a set of different network interfaces (e.g. wired and wireless interfaces, or different types of wired or wireless interfaces). Data is written to the network interface for transmission or read from the network interface for reception under the control of the software application running in the CPU 901;
a graphical user interface unit 905 for receiving user input or displaying information to a user;
a 906 HD-rated hard disk
a 907 I/O module for receiving/sending data from/to external systems such as a video source or display.

The executable code can be stored either in read-only memory 903, on the hard disk 906, or on a removable digital medium such as a disk. In one variant, the executable program code can be received by means of a communication network, via the network interface 904, in order to be stored in one of the storage means of the communication system 900, such as the hard disk 906, before being executed.

The central processing unit 901 is adapted to control and direct the execution of instructions or portions of software code of the program(s) according to the embodiments of the invention, these instructions being stored in one of the aforementioned storage means. After power-up, processing unit 901 is able to execute instructions from main RAM 902 relating to a software application after these instructions have been loaded from ROM program 903 or hard disk (HD) 906, for example. Such a software application, when executed by CPU 901, results in the execution of method steps according to embodiments.

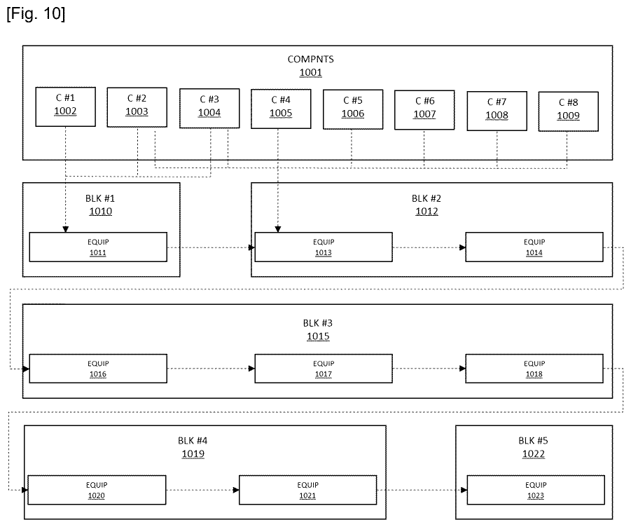

To illustrate the implementation of a process according to embodiments in an industrial plant, an example of an industrial plant is shown in FIG. 10.

The plant comprises a set (COMPNT) 1001 of tanks 1002 to 1009 of components (C#1, . . . , #8). Each tank contains a component used in the manufacturing process of a product within the plant. For example, the end product is a cake, and the tanks contain the components of this cake, such as milk, sugar, flour, eggs, oil, yeast, almonds and fruit.

The plant also comprises various blocks (BLK #1, . . . , #5) of equipment (EQUIP), 1010, 1012, 1015, 1019, 1022 using the various components. For example, block 1010 comprises a single piece of equipment 1011 for sourdough culture. Block 1012 comprises two pieces of equipment 1013, 1014, respectively for kneading dough and resting dough. Block 1015 comprises, for example, three units 1016, 1017, 1018 for molding, baking and cooling, respectively. Block 1019 comprises two pieces of equipment 1020, 1021 for demolding and checking the cakes. Finally, block 1022 includes equipment 1023 for packaging the cakes.

For example, components C#1 to C#3 are supplied to sourdough culture equipment 1011, and components C#2 to C#8 are supplied to kneading equipment 1013. The output from the 1011 equipment is sourdough, which is also supplied to the kneading equipment, which in turn produces a cake dough. This dough is supplied to equipment 1014 for resting. The rested dough is then supplied to equipment 1016 to mold the cakes, which are then supplied to equipment 1017 for baking. Once baked, the cakes are supplied to equipment 1018 for cooling. They are then demolded in equipment 1020. Quality control is carried out in equipment 1021. Once the non-conforming cakes have been filtered, they are packaged in equipment 1023 for transport to their place of distribution.

In the following, the baking step in equipment 1017 will be particularly considered. For the implementation of the contextualization engine, please refer to the description above, and in particular to the flowchart shown in FIG. 8.

It is assumed that the equipment comprises two ovens, each equipped with a sensor measuring the temperature inside the oven and a sensor measuring the humidity inside the oven. Each oven is also equipped with an automated control system which, at any given moment, is able to send back the state of the oven (baking, waiting) as well as the batch number of the dough used for the production being baked.

It is also assumed that dough quality data (dry matter, viscosity) are collected for each batch number of dough used.

The implementation of a process as described above in this plant enables the following operations to be carried out.

Firstly, data from the various sensors, state information from the two furnaces and information on the batch number of the dough used are collected. The sensor data is stored. This corresponds to steps 802 and 807 already described above.

Traceability data is then generated based on the furnace state information. This corresponds to step 809 described above. In the present example, each time the oven state changes from “waiting” to “firing”, a new operation is created, comprising a single phase, with the date and time of the phase start and the date and time of the transition. A unique operation number is then generated, for example, in the format YYYY-MM-DD-XXX (with YYYY being the year, MM the month, DD the day and XXX a sequential number reset to 0 at the start of each production day). The phase end date and time, determined later, corresponds to the date and time when the transition from “firing” to “waiting” state is established. The location assigned to this phase is the reference of the oven whose state data was used to create the operation. This traceability creation process is performed in parallel on data from both furnaces. The collection, extraction and storage of data useful for this creation correspond to steps 802, 804 and 806.

Again as described above for steps 803, 805, 808, 1→N genealogy information is generated by associating the batch number of the paste used (upstream) with the operation number that has just processed the paste (downstream).

For example, in accordance with step 811 already described, a first traceability merge operation is used to calculate temperature-derived indicators for each baking operation. For the operation in question, the temperature sensor corresponding to the oven designated in the location is selected. Then, according to step 812, the data from this sensor within the time window between the start and end of the phase as described in the operation is selected. According to step 813, the aggregation operations on these data are then performed. In this example, three different indicators can be calculated: average, minimum and maximum temperature. All three results are stored for this operation, to be used at a later date.

To complete the data related to the baking operation, a genealogy merge operation is performed in accordance with step 814. The quality data (dry matter, viscosity) corresponding to the batch number of the paste used in the cooking operation is retrieved and stored at the cooking operation.

At the end of this process, for each baking operation, a unique operation number in the form YYYY-MM-DD-XXX, a phase with a start date/time and an end date/time, and five data items are available: average temperature, minimum temperature, maximum temperature, viscosity of the dough used, dry matter of the dough used.

For each baking operation, the genealogy data gives the batch number of the dough used (Upstream), the type of genealogy: 1→N and the unique baking operation number of the form YYYY-MM-DD-XXX in which the dough was used.

All this data is used to control the system, determining the setting to adjust the oven temperature.

The present invention has been described and illustrated in this detailed description with reference to the accompanying figures. However, the present invention is not limited to the embodiments shown. Other variants, embodiments and combinations of features can be deduced and implemented by the person skilled in the art from reading the present description and the attached figures.

To meet specific needs, a person skilled in the field of the invention may apply modifications or adaptations.

In the claims, the term “comprise” does not exclude other elements or steps.

The various features presented and/or claimed can advantageously be combined. Their presence in the description or in different dependent claims does not exclude the possibility of combining them. Reference signs should not be understood as limiting the scope of the invention.

1-14. (canceled)

15. A method of processing state data of an industrial installation for controlling at least one piece of equipment of said installation, wherein said state data comprises at least one of data from sensors of said installation and values of state variables of equipment of said installation, the method comprising the following steps:
extraction of state data relating to a phase of an operation carried out within said industrial plant,
generation of traceability data relating to a position of said phase in a flow of operations within said industrial plant,
aggregation of said state data and said traceability data to generate operation data specific to said operation in said flow.

16. The method according to claim 15, wherein said generation of operation data comprises the application of a time window relating to said phase of said operation.

17. The method according to claim 15, wherein said generation of operation data comprises the location of data relating to said phase of said operation.

18. The method according to claim 15, wherein said operation data is transmitted to a control module of said at least one piece of equipment.

19. The method according to claim 15, further comprising the following steps:
generation of genealogy data relating to a sequencing of said operation in said flow of operations within said industrial plant,
aggregation of said operation and genealogy data.

20. The method according to claim 19, in which, the generation of genealogy data comprises the creation of a link relating to their data between one or more downstream operations using products from one or more upstream operations in a process implemented within said plant.

21. The method according to claim 20, wherein said genealogy data enables the determination of data for one or more downstream operations from data relating to one or more upstream operations by application of a function representative of said link.

22. The method according to claim 21, wherein said operation performed within said industrial plant is an upstream operation whose results are used by a plurality of downstream operations, and wherein said operation data specific to said upstream operation generated is used for the generation of operation data specific to said downstream operations.

23. The method according to claim 21, wherein said operation performed within said industrial plant is a downstream operation using results from a plurality of upstream operations, and wherein the generation of said operation data specific to said downstream operation comprises the application of a function for merging the operation data specific to said upstream operations.

24. The method according to claim 19, wherein the aggregation of said operation and genealogy data is stored in a data structure comprising
a first set of data describing the operations of said operation flow,
a second set of data describing the equipment of said installation for implementing said operations of said flow of operations and associated with said sensors of said installation,
a third set of data comprising said aggregation of said data.

25. The method according to claim 24, in which, for each operation of said flow, the first data set comprises a subset of data describing the operating phases of said operation.

26. The method according to claim 24, in which the third data set comprises, for each operation of said flow, a type of genealogy for indicating a sequencing link between said operations of said flow of operations.

27. The method according to claim 19, wherein the aggregation of said operation and genealogy data is transmitted to a control module of said at least one piece of equipment.

28. A device comprising a processing unit configured to implement steps according to a method according to claim 15.
